(19) United States
(12) Patent Application Publication
(10) Pub. No.: US 2021/0312556 A1
(43) Pub. Date: Oct. 7, 2021

(54) System and Process For Presenting Monetary Account Value or Value Changes in the Form of Traditionally Non-Monetary Digital Objects Displayed on Authenticated Computer Devices

(71) Applicant: Troutwood, LLC, Pittsburgh, PA (US)

(72) Inventors: Eugene M. Natali, JR., Pittsburgh, PA (US); Jeffrey Richard Davidek, Pittsburgh, PA (US); Dorian Brown, Pittsburgh, PA (US)

(73) Assignee: Troutwood, LLC, Pittsburgh, PA (US)

(21) Appl. No.: 17/223,828

(22) Filed: Apr. 6, 2021

Related U.S. Application Data
(60) Provisional application No. 63/005,872, filed on Apr. 6, 2020.

(51) Int. Cl. G06Q 40/06; G06T 11/20

(52) U.S. Cl. CPC G06Q 40/06; G06T 11/206

(57) ABSTRACT

An investor feedback system is provided having a single general user interface; and
a computer connected to the single general user interface and having:
a computer readable storage device having a database module for collecting, storing, and linking data associated with financial performance of a user account;
   a central processing unit connected to the single general user interface and the computer readable storage device, and running a plurality of core modules to display a progressive series of images for an action element representing the financial performance of the user monetary account, the plurality of core modules include:
      a user goal selection module configured to allow a user to set a financial goal for the monetary account in numerical value; and
      a data display module configured to present a graphical representation of financial performance of the financial goal in view of current status of the monetary account.

### CROSS-REFERENCE TO RELATED APPLICATION

This application claims the benefit of U.S. Provisional Patent Application No. 63/005,872, filed on Apr. 6, 2020.

### FIELD OF INVENTION

The present invention relates to an investor feedback system to graphically display and track financial performance, by digitally presenting and displaying value of monetary or investment accounts, for example, through the use of non-monetary objects, and more particularly the investor feedback system provides an investor feedback module that has one or more of an authentication module, a user goal selection module, a user action module, a data aggregator module, a graphical conversion module, and a data display module. The investor feedback system provides systems and methods, and utilizes algorithms for displaying value or progress toward a financial goal, in the form of digital traditionally non-monetary objects on a personal computer or mobile device display utilizing software and data networks.

### BACKGROUND

Approximately 115 million Americans do not invest. Only 3% of children born in 2019 are likely to have a pension fund. There is a student loan crisis, which continues to grow. Corporations and even municipal and state governments are freezing or eliminating their pension plans. The minimum age for Social Security eligibility has risen and may continue to rise as its Trust Fund deficit grows. This cumulative reduction of the United States retirement safety net is an issue of national importance. The demand and need to help Americans, particularly young Americans, develop viable plans to achieve financial stability is very high. Behavioral Finance has demonstrated the efficacy and impact that visual imagery can have on likelihood of goal achievement. Furthermore, research has shown that associating a sentimental item with a savings goal resulted in an increase in motivation to improve savings behavior, and was demonstrated to increase the amount saved as a result of being associated with a sentimental item.

Many individuals are intimidated by the financial services industry. Common reasons include complex jargon, high minimum account size requirements which many individuals cannot meet, lack of experience, lack of education, and software programs or interfaces that are unengaging, difficult to understand, or otherwise not user friendly.

One possible solution to this problem is to stimulate investor interest and provide gratification through measurable goal achievement recognition, which may be provided in graphic form. This may be accomplished by applying gamification techniques to the software user interface of investment account owners, potentially making the investment experience more relatable, gratifying, and enjoyable.

### SUMMARY

What is described herein achieves the goal of stimulating investor interest and provide gratification through measurable goal achievement recognition, by providing an investor feedback system that utilizes graphical information to convey financial information or progress towards a goal.

In an exemplary embodiment, there is provided an investor feedback system, with a single general user interface, and a computer connected to the single general user interface and having: a computer readable storage device having a database module for calculating, collecting, storing, and linking performance benchmarking data associated with a specific entity; a central processing unit connected to the single general user interface and the computer readable storage device, and running a plurality of core modules to display a progressive series of images for an action element representing financial performance of a user monetary account, the plurality of core modules include: a user goal selection module configured to allow a user to set a financial goal for the monetary account in numerical value; and a data display module configured to present a graphical representation of financial performance of the financial goal in view of current status of the monetary account.

An embodiment of the investor feedback system may further comprise a user action module configured to customize of the graphical representation by selecting an action element consisting of a progressive series of images related to a single graphical form. The graphical form may be, for example, a multicellular organism and the progressive series of images shows growth or decay of the multicellular organism. In another example, the graphical form may be a tangible item and the progressive series of images shows addition or destruction of the tangible item.

In an exemplary embodiment, the investor feedback system may have a data aggregator module configured to gather a real-time value of a user's financial account information related to performance of the monetary account in view of the financial goal. The data aggregator module may communicate with a third party financial institution to receive the real-time value of the user's financial account information. The data aggregator module may gather the real-time value of a user's financial account information periodically.

In an exemplary embodiment, the investor feedback system may have a graphical conversion module to convert real-time value of the user's financial account information into a selected image of progressive series of images in view progression of the financial goal. The graphical conversion may determine a current percentage of progression of the financial goal. The graphical conversion may determine the current percentage of progression of the financial goal in view of a previous status of progression.

In an exemplary embodiment, the investor feedback system has a data display module that provides an animation of the progressive series of images up to the current percentage progression of the financial goal in view of a previous status of progression. The data display module may include congratulatory or encouraging messaging upon display of the graphical representation. The graphical representation may be accompanied by audible commentary.

In an exemplary embodiment of the investor feedback system, the monetary account may be a plurality of financial accounts.

### BRIEF DESCRIPTION OF THE DRAWING(S)

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram of hardware infrastructure for an investor feedback system according to the invention;

FIG. 2 is a schematic diagram of an investor feedback system according to the invention;

FIG. 3 is a flow chart of exemplary action elements selectable by the user, for an investor feedback system according to the invention;

FIG. 4 is a schematic diagram of hardware infrastructure for front end and back end framework of an investor feedback system according to the invention;

FIG. 5 is a flow chart of exemplary steps performed by user authentication module for an investor feedback system according to the invention;

FIG. 6 is a schematic diagram of exemplary connection between a front end and a back end framework of an investor feedback system according to the invention; and

FIG. 7 is a schematic diagram of exemplary protocol between a front end and a back end framework of an investor feedback system according to the invention.

FIG. 8-15 is a representative depiction of a progression series for one embodiment of an action element in the form of a tree, proceeding from an initial depiction in FIG. 8, with the final depiction in the form depicted in FIG. 15;

FIG. 16 is an exemplary embodiment of a table of progress levels and milestone events for the action element progression depicted in FIGS. 1-8; and

FIG. 17 is an exemplary embodiment of a process flow according to the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

Other systems, methods, features and advantages of the invention will be or will become apparent to one with skill in the art upon examination of the following figures and detailed description.

In an exemplary embodiment, the invention provides an investor feedback system, having an investor feedback module and various service modules within the investor feedback module for providing feedback to the investor, and associated methods for displaying the data for one or more user accounts, specifically, the monetary account value and/or the monetary account changes in value (delta), and provides feedback to the viewer that can stimulate and encourage user interest by employing gamification techniques, whereby progress towards a defined goal, a total account value and/or advancement of one or both of the values is displayed digitally in graphic form using a graphic character or element, which may be static or animated, on the display screen of a computer or mobile computing device.

In an embodiment, the investor feedback module of the invention is configured to provide feedback to an investor or account holder, and further encourages the account holder's interest and activity, by applying gamification techniques to the practice of reporting and tracking investment and financial performance. The use of gamification, financial psychology and behavioral techniques to reinforce investor interest, as described herein, offers an improvement over the traditionally employed techniques for providing feedback to the investor that had provided feedback concerning a user's investment account value and change in value presented by financial service providers in traditional numeric form, or depicted using line charts, bar charts, and pie charts, or by some combination thereof. While certainly accurate, the traditional forms of feedback are often glossed over or ignored entirely by the reviewer, and many investors may find non-traditional and non-monetary representations of a user's account value to be more meaningful, enjoyable or engaging. The popularity of behavioral finance techniques, gaming applications, including computers and mobile phones, such as iOS and Android devices, is testament to the attraction of gamification and its ability to cultivate user engagement.

The investor feedback system may be a cloud-based, such that the information may be accessed and distributed via the internet and may utilize one or more servers or data processors that are remote from the location of the user. The terms “cloud-based investor feedback system” and “investor feedback system” will be used interchangeably herein. The investor feedback system 100 compares financial performance of a user account to adjusted goals, and provides performance feedback through dynamic illustrations that can be viewed by the user, employs software and hardware.

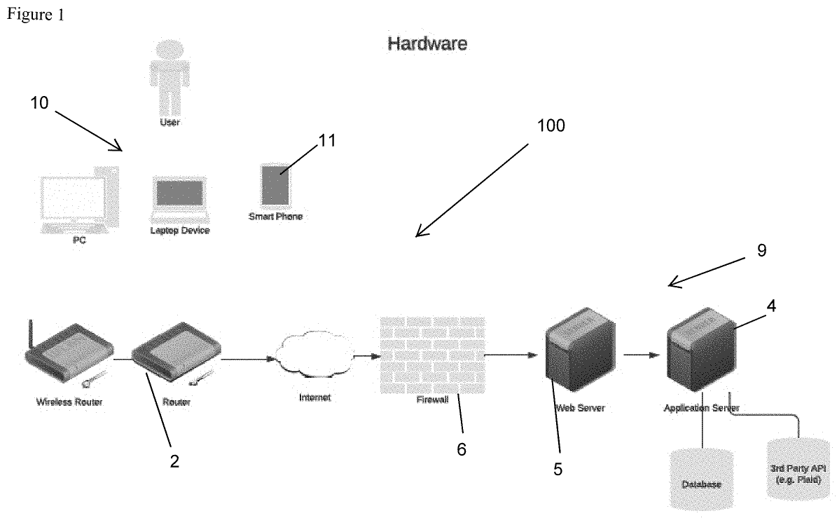

With reference to FIG. 1, the investor feedback system provides, or is configured to access a database, which contains electronic files representing financial investment fund account information for access by one or more users, who may view the information on any suitable display format, including screen displays of a computer, cellular phone, tablet, etc.

The investor feedback module of the investor feedback system may include several modules for carrying out the invention, and by way of overview, including: an authentication module ensuring that the user's identity is authorized or authenticated; a data aggregator module to access the user's financial account information; a graphical conversion module to convert the financial account information into a visually interesting format that conveys performance towards a goal for the user; and a data display module to subsequently present the financial performance on the computing device, thereby providing visual feedback in the form of one or more of digital graphic, graphics, animation, or animations, as will be discussed. Additionally, the investor feedback system 100 may optionally include a goal selection module to allow for the user to set a financial goal to be achieved. Further, a user action module may be provided to allow the user to customize the display by selecting the category of element to be displayed, whereby the user may select a representation element from a provided object library.

With reference to the figures referenced herein, various aspects of the hardware, modules and methods of use of an exemplary embodiment of the investor feedback system are further described.

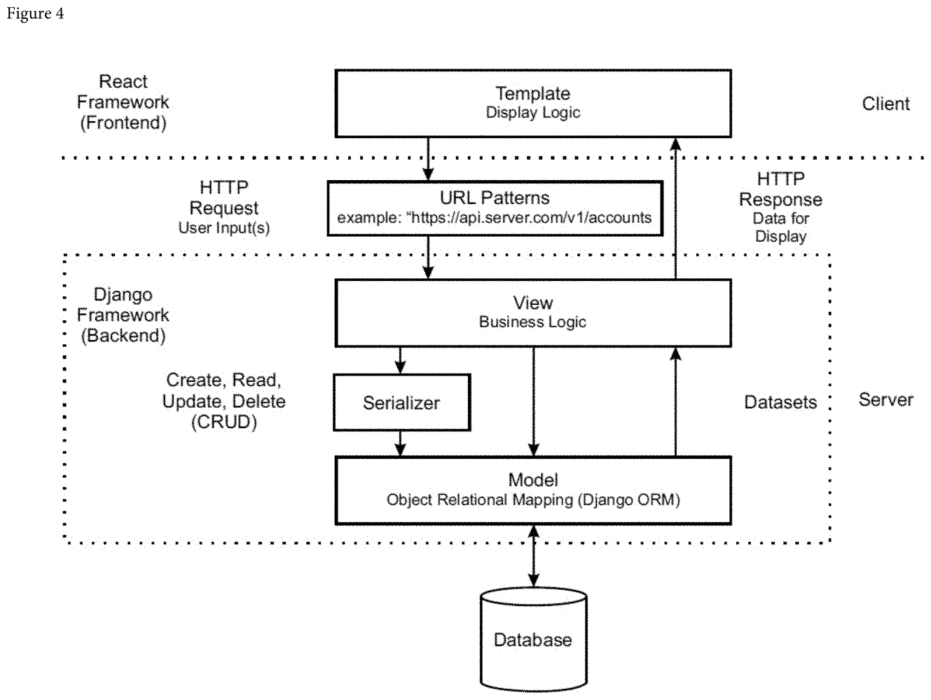

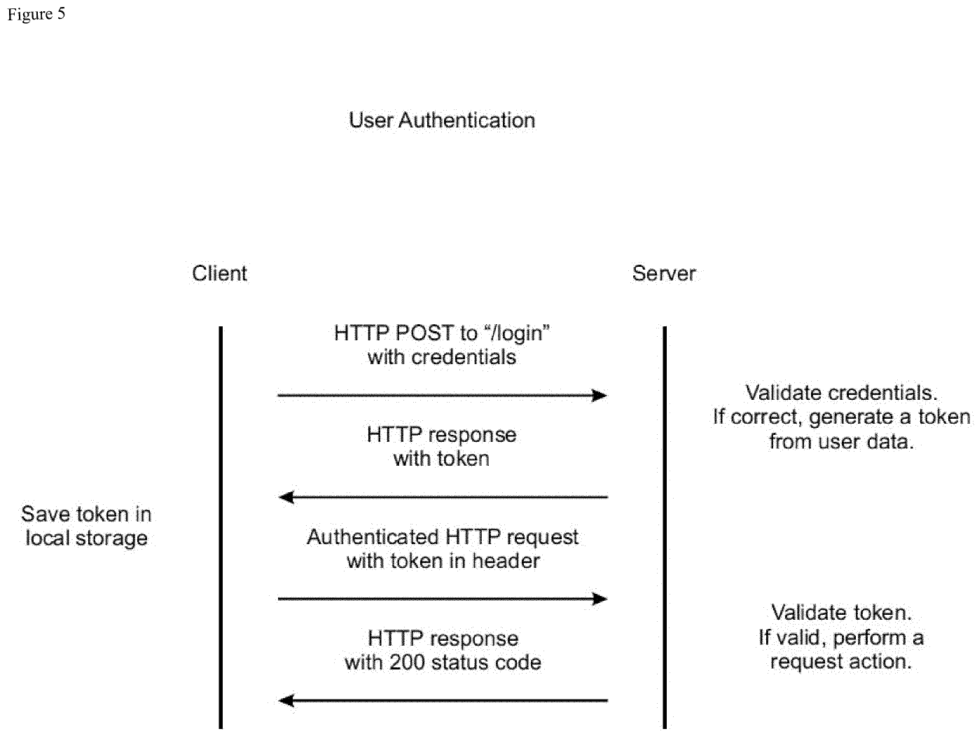

The hardware infrastructure for an embodiment of the investor feedback system 100 will be described. In an exemplary embodiment, the hardware infrastructure has a system architecture depicted with reference to FIG. 1, and is built on one or more network routers 2 (for instance, a wireless router) and connected to a database application server having access to one or more databases files, while also utilizing known hardware components, including a web server 5, a firewall 6, a network 9, and the computing device 10 of the user. It is contemplated that, in an embodiment where the user's computing device is a terminal such as a PC or laptop, for example, the computing device 10 may be directly connected by network communication cable to the router 2, and the wireless router depicted may not be necessary. More commonly, the user end of the network 9 is provided with a computing device 10 that is a laptop, PC, tablet, or smart phone that can communicate wirelessly, and access the internet through a wireless communication system, such as a wireless router, that may connect directly to the internet, or be directed through a network router 2 in order to access the internet, as shown in FIG. 1. In an embodiment, the computing device 10 may be a tablet computer or smart phone with a touchscreen display 11. The touchscreen display 11 may use finger or stylus gestures to navigate the general user interface (GUI) provided on the screen by the software. However, one skilled in the art should appreciate that other implements could be used; including a computer mouse, a keyboard, or joystick. In fact, one skilled in the art should appreciate that the computing device may be a physical computer and could be, but not limited to, a desktop computer, a laptop computer, or a cell phone, and utilize a downloaded app or web browser. The computing device is to be provided with memory device that is a storage device having computer components and recording media used to retain digital data. The processor of the computing device is a central processing unit (CPU) that manipulates data stored in the memory device by performing computations. The interaction and communications between the graphical user interface and the display visible to the user (the front end) and the interactions with the database, or financial account information (the back end) are depicted in the simplified schematic of FIGS. 4 and 5.

The investor feedback system 100 allows a user to access a plurality of user options through the computing device 10 and a network traffic information on the database application server 4 (i.e., SQLServer or PostgreSQL (also known as Postgres) or newer) that connects to a web server 5. The web server 5 functions as a way for the network router 2 to communicate to the database application server 4 using an application-programming interface (API) for communications between the computing device 10 and the database server 4. In an embodiment, the application database server 4 may house a data aggregator API that can connect to one of a database file for a financial institution, or alternatively to a third party API that facilitates electronic access to the financial information of the user's financial account, using techniques known to those skilled in the art. A firewall 6 may be integrated for security purposes such as, but not limited to, blocking unauthorized access to the web server 5 and the resulting unauthorized communication thereto. The investor feedback system 100 is designed to run through the computing device 10 utilizing the investor feedback files for the application or program that are preferably loaded onto the user's computing device 10, such as into the memory of the computing device, and supplemented with information communicated through the network as will be discussed. It is contemplated that, alternatively, the investor feedback files may be downloaded through the network 9 from an application server 4. The investor feedback system 100 is designed to run through the computing device 10, and through a plurality of modules utilized in the investor feedback system that may be downloaded and function over any suitable network system 9, including personal area networks (PANs), local area networks (LANs), campus area networks (CANs), wide area networks (WANs), metropolitan area networks (MANs) and any new networking system developed in the future. In an embodiment, network 9 may be a set of hardware, software, and protocols that is configured for electronic communication. For example, network 9 may be any one of a global data network (e.g., the Internet), a regional data network, mobile/cellular wireless network, or a local area network. In a preferred embodiment, the network 9 represents a packet-switched network for routing various data. The network uses common high-level protocols, such as TCP/IP and may comprise multiple networks of differing protocols connected through appropriate gateways.

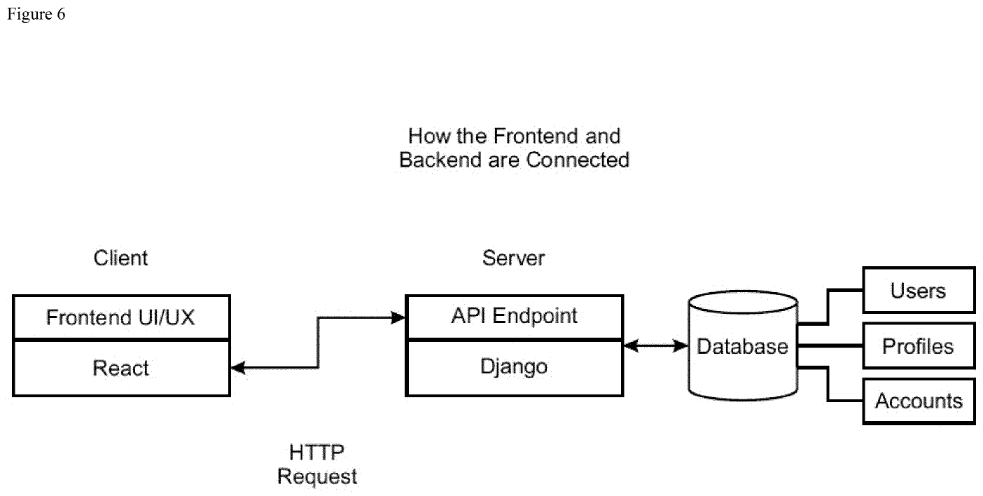

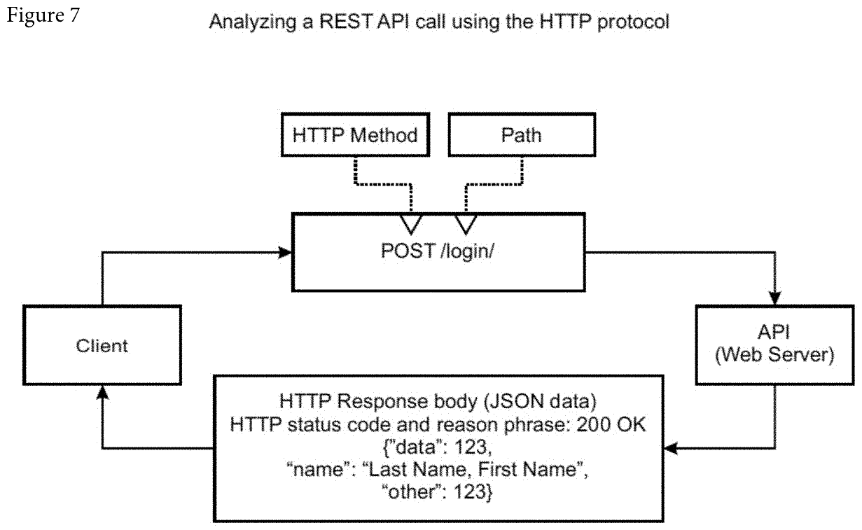

One skilled in the art should appreciate that the investment feedback system 100 can be maintained solely through the computing device 10, as the investment feedback files can be pre-loaded to the computing device 10. In such an instance, the user may input details regarding the current financial account balance, thereby avoid the need to have the computing device 10 access a third party databases or API to update the account information via network 9. In the shown embodiment, the user may connect to the network router 2 using the computing device 10 and update information through the network 9. In the shown embodiment, the user connects to the network interface using the computing device 10 through the router 2 for instance. FIG. 4 illustrates an exemplary embodiment of the front end and back end framework of the investor feedback system 100. FIGS. 6 and 7 also provide exemplary architecture and protocol for the investor feedback system 100. Though one skilled in the art would appreciate that other hardware and protocol designs are possible as long as such modifications would not divert from the spirit of the invention.

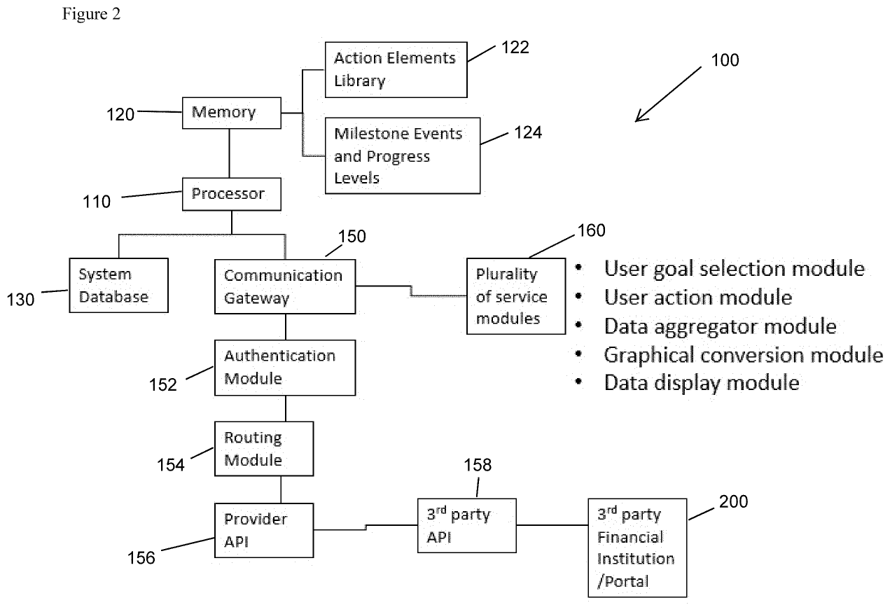

With reference to the schematic depiction of the investment feedback system 100 shown in FIG. 2, the computing device, as discussed above, and as known to those of skill in the art, generally includes a general user interface that can be detected on the display, a memory device 120, and a processor 110.

An exemplary embodiment of the process flow and interactions between component devices for the operation of the investor feedback system will be described with reference to the simplified schematic diagram of FIG. 2. The investor feedback system 100 includes a processor 110, having a memory 120, as may be associated with the computing device described previously, an application database 130, which may also be referred to as the system database.

As one of ordinary skill in the art would appreciate, the system database 130 may be any type of storage device or storage medium such as hard disks, cloud storage, CD-ROMs, flash memory, DRAM and may include a collection of devices (e.g., Redundant Array of Independent Disks (“RAID”)). The information to and from the database can be accessed over a data network 9 as will be described, through respective network connections, for example, in the manner depicted in FIG. 1. These network connections may be any suitable form, including wired or wireless, and may be implemented using any known suitable protocol.

The integration system 100 further includes a communication gateway 150 and a plurality of service modules 160 executable by the processor 110. The service modules 160 may include at least one or more of: an authentication module; a user goal selection module; a user action module; a data aggregator module; a graphical conversion module; and a data display module, as will be discussed. For exemplary purposes, the authentication module is depicted in FIG. 2.

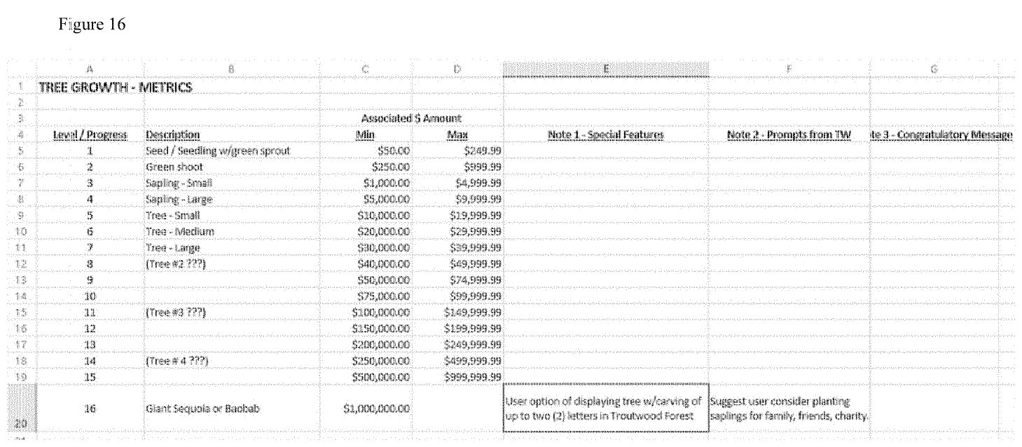

The processor 110 shown in FIG. 2 may be any type of computer processor known to those with ordinary skill in the art and capable of executing the processes described herein. The memory 120 connected to the processor 110 is any non-transitory computer readable medium known to those with ordinary skill in the art including, for example, persistent memory such as magnetic and/or optical disks, ROM, and PROM and volatile memory such as RAM. The memory 120 stores a plurality of algorithms executable by the processor 110. The various algorithms, when executed by the processor 110, implement an authentication module 152 and a routing module 154 of the communication gateway 150 and may also implement the services modules 160 as described in greater detail below. The memory 120 may also store a library of action elements 122 and a table of progress levels and milestone events 124 (for example, as shown in FIG. 16).

The communication gateway 150, in addition to the authentication module 152 and the routing module 154, includes a provider Application Programming Interface (“API”) 156 and a third party API 158 as shown in FIG. 2. The provider API 156 and the third party API 158 are each a set of software instructions stored on the system memory 120; each API 156, 158 is a set of subroutine definitions, protocols, and tools that, when executed by the processor 110, permits communication between disparate software components. Each API 156, 158 is configured to convert electronic data between different formats, such that the same electronic data is readable by each of the disparate software components. In an exemplary embodiment, the provider API 156 and the third party API 158 are both configured to convert electronic data between a JavaScript Object Notation (“JSON”) format and an Extensible Markup Language (“XML”) format. As would be understood by those with ordinary skill in the art, conversion between other known formats is also possible. In an embodiment of the invention, each API 156, 158 is a Representational State Transfer (“RESTful”) API, with a schematic of the interactions depicted in FIG. 7.

The investor feedback system 100 may be connected to and communicate with one or more third party financial institutions or financial portals 200 through the communication gateway 150 (e.g., over the internet) to integrate data related to the user's financial accounts across the investor feedback system 100. Portions of the investor feedback system 100 may be cloud-based via the Internet and may be located remotely from the user processor 110 and third party financial institutions 200.

The investor feedback system may employ an investor feedback module utilizing, in an exemplary embodiment, the hardware depicted in FIG. 1. The investor feedback system 100 further relies on actions carried out by a plurality of service modules 160 helpful for carrying out various aspects of the invention, as will be described.

Authentication Module

The authentication module allows for the secure log-in of the user, such as by using a password and username for the account that may be selected by the user during initial setup, and stored in memory for authenticating follow on events. It is also contemplated that alternatively, or additionally, one or more of personal identification number (PIN), challenge response, security token, hardware token, signature recognition, facial recognition, fingerprint scan, biometric data, and two-factor authentication credentials may similarly be employed to authenticate the user, as will be understood by those of skill in the art. The authentication module ensures that the user's identity is authorized or authenticated. Once the user's identification has been authenticated, the investment feedback system may be more fully utilized, such as by performing additional service modules, as will be discussed. Further, the user credentials for an authenticated user may be conveyed securely through the communication gateway, as may be required for interactions with a third party API 158, and/or for access to a third party portal, such as a for a financial institution hosting the user's account.

An example of protocol for the authentication module 152 is shown in FIG. 5, showing the interactions between client and server to verify and authenticate the user by providing login credential information, and token exchange.

Goal Selection Module

Once the user has been properly authenticated, the user may be presented with the user goal selection module. The user goal selection module is configured to allow the user to set a financial goal to be achieved, typically a monetary account value, and therefore is a numerical value that the user wishes to achieve within his account(s). In an embodiment, the goal may represent the desired value for a single account. In an alternative embodiment, the goal may represent the desired total value of a plurality of accounts, including any number or type of suitable financial accounts, such as any one or more of savings, checking, retirement, and/or investment accounts. In an embodiment where the authenticated user has previously selected a goal, the user may be asked to confirm the goal, or the system may by default utilize the previously selected goal within the investment feedback system, unless the user selects to revise or update the selected goal. The user goal, if created new or revised is to be stored in memory 120 of the computing device 10, and may be recalled from memory for future sessions with the same authenticated user. The user may select relative and/or absolute measures of progress towards goal completion and %/unit completion.

In an embodiment, the user may be provided an option to select a time period in which the goal is sought to be achieved, or select an update interval, such as by progress towards the goal, which can determine the frequency of which the data is updated within the system.

User Action Module

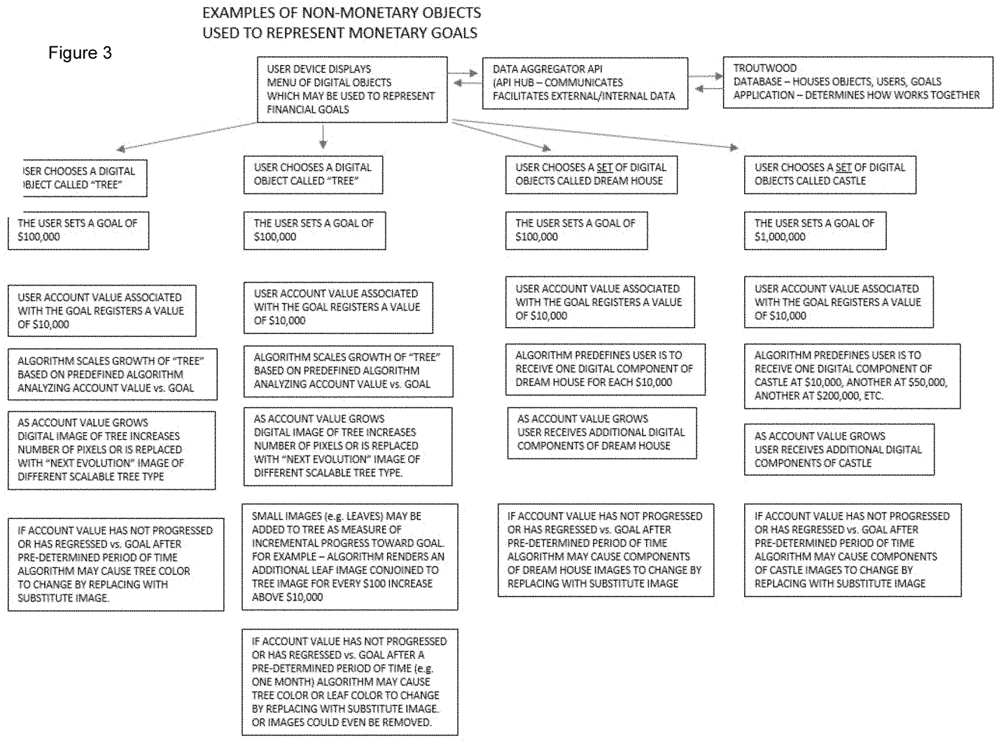

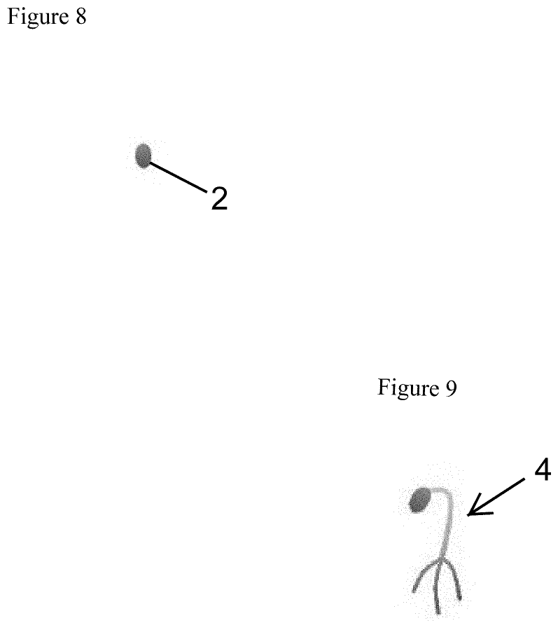

The user action module is configured to allow the user to customize the graphical display by selecting the nature of the element displayed. The user action module enables the user to select a representation of an action element from an object library. The action elements library may be a plurality of action elements that are stored in memory of the computing device, and can be used in the graphical display. Each of the action elements in the library are provided with a progression imagery of a user selectable item, such as a vehicle, a residence, a tree, that can vary from a basic or simple starting point, and can grow, or be modified to represent a more advanced form. For example, FIGS. 8-15 depict a representative exemplary progression of a seed to a mature tree, with alternative object elements described with reference to FIG. 3. The files for the object library may be stored in the memory 120 of the computing device 10, and may be updated to provide additional user selectable objects for use in the graphical depictions within the investor feedback system, and may be employed to graphically depict the user's progress towards the financial goal selected.

In another exemplary embodiment, the user may choose from a menu, presented in any suitable format, for example, a drop-down menu of many different types of digital objects, that may be animated or graphically depict progression in the value and contributions to the account or identified goal. It is contemplated that substituting the focal element for another would be capable of conveying feedback about the account, and could be readily tailored to the user's subjective interests. As non-limiting examples, the element depicted may be a form of transportation, such as car, motorcycle, boat, airplane, rocket, where basic rudimentary versions of each element could be depicted at smaller account values, and as the account increases in value, improvements or additions to the element may be depicted, such as the car transforming from a child's toy automobile, and progress through various stages of automobile development, prestige, and flashiness. Alternatively, the user may choose an object that represents a tangible, specific sought after goal relevant to that user, for example, the user may be saving towards a specific car brand, in which case, the depicted object may be that brand vehicle, which progresses in a series where parts of the vehicle are added on in proportion to progress towards goal. Alternatively, the goal may be an object, such as a wedding ring, and the progression may be depicted by filling in pixels, or parts of the image, as user progress towards the goal is made. In another embodiment, the object may represent a vacation trip, paying off mortgage, or paying off student loans, which one utilizing the teachings herein could convert to a progression series that can be displayed. The user may be able to submit an image of the user's choosing, to be stored into memory, which image could then be filled in (such as by adding pixels, or revealing more of the image, as progress is made towards the selected goal, providing the user great flexibility, personalization and/or customization, in the depicted object on the display. Rewards for achievement may include unlocking features, skins, or color schemes for this, or any of the embodiments described herein. Alternatively, it is contemplated that the element may be, for example, a house, and initially be a modest home, tent, or doll house, and transform into a more elegant/desirable home, then progress to a mansion or high rise building, as the account value increases. Alternatively, the element may be an animal, and may transform or grow, as the value of the account increases. In an embodiment, the depicted element may mimic character(s) known from tamogotchi devices, where the care and growth of the digitally depicted character is dependent upon the growth of the user's account, and is graphically conveyed, and provides feedback to the user. In any of the embodiments described herein, the main emphasis is the conveyance of valuable feedback to the user concerning the health/performance of the investment account, as may be conveyed graphically in still images, gifs, or animated sequences, through the software.

Data Aggregator Module

The data aggregator module allows the receipt of accurate and timely financial account information for use by the investment feedback system 100. In an embodiment, the data aggregator module is configured to allow access to the user's financial account information, such as by linking the system 100 to the user's financial account information. In an embodiment, the data aggregator module relies upon the communication by the provider API 156 with the third party API 158, which in turn may be in communication with the third party financial institution 200, or a communication portal for the third party financial institution, as depicted in FIG. 2. Once the provider API 156 has received the updated account information for the user, the value of the account(s) are communicated to the processor for processing in an algorithm, as will be discussed. Once an account is properly linked within the system to an authenticated user, the data for the monetary account value may be periodically updated, such as daily, or at a frequency specified by the user.

In an alternative embodiment, the data aggregator module provides the user the option to enter the value of the account(s), and thereby avoids the need to have the system linked or otherwise in electronic communication with the financial institution housing the account. This may allow the use of the system in an offline manner, without access to the internet.

In an exemplary embodiment, the investor feedback system may provide an application server that is configured to access a user's financial account information, which may be provided by a financial institution that provides updated information on the current monetary value, may further provide the historical value of a user's account. The financial information may be accessed through an application-programming interface (API), such as Plaid, or any suitable API that allows the secure sharing of a user's financial account information with applications or programs on an authenticated computing device; or the investor feedback system may alternatively connect directly to the appropriate financial institution hosting the user account, e.g., through a portal or internet accessible server, and thereby can provide current financial information status for the user account. For either suitable source of financial information, such as the third party API, or the financial institution, the application server should be capable of accessing the user's financial information electronically in a secure manner, using techniques known to those skilled in the art. The financial account information may be accessible via a wired or wireless network communication connection, or otherwise accessible, such as through a communication protocol, for example, using the internet to access the application server, which in turn can access the account information through the API or communicating directly with the financial institution such that the system may transmit the data concerning the account in a secure manner, utilizing the components of the network depicted to an authenticated client device, which may be any suitable end user device, such as a computer or mobile device capable of providing the information on a display.

Graphical Conversion Module

The graphical conversion module utilizes the data from the data aggregation module, the goal selection module, and the user action module, and utilizes an algorithm to convert the financial account information into a graphical depiction format represented by the action element selected by the user. The graphical depiction thus conveys information about the performance of the user account in progressing towards a goal for the user. The algorithm is described below.

The algorithm is a routine that may be performed by the processor of the computing device to determine the progress towards a user defined goal, or an account value determined by the user.

In an exemplary embodiment, the algorithm is a routine according to the following set of instructions:

```
MaxObjectValue = 1000.00
          (Account Value)
              ↓
            $100.00
              ↓
Δ ComputeObjectGrowthPercentage (AccountValue) {
  ObjectPercentage = Value AccountValue / MaxObjectValue//0.10 ≈
10%
  * PresentGraphicalObject(ObjectPercentage)
  }
Δ PresentGraphicalObject( ObjectPercentage)  {
  ObjectImages = GrowTo (percentage ObjectPercentage)
  Animatewithimages (ObjectImages)  //animates object on user
  Interface
  }
Δ GrowTo (Percentage) {
  CollectionOfImageData [ID1,ID2,ID3,...] //ID = Image Data
  NumberOfImageData = CollectionOfImageData.count
  NumberOfGrowthImageData = (NumberOfImageData * Percentage).
  round
  ObjectGrowthImageData = [ ]
    For each (index, ImageData) in CollectionOfImageData {
      If Index = = NumberOfImageData − (NumberOfImageData) −
        (NumberOfGrowthImageData)
        Exit
      EndIf
      ObjectGrowthImageData + ImageData
    }
  Return ObjectGrowthImageData
  }
```

In carrying out the above example code, the code may require determining the current percentage of the milestone achieved. This may be automatically determined by accessing the current account balance, as provided by the data aggregator module. The image object growth percentage is determined a formula where the account value is the numerator, and the maximum object value (the milestone next to be achieved) is the denominator. If the result of that division is multiplied by 100, the result is the percentage of the next milestone currently reflected by the current account value, the “present graphical object percentage”. In another embodiment, the user need not set a goal, but rather progress is made by increasing the value in the account, for example, a graphic tree may add leaves onto a tree as the value of the account increases, and larger increments of leaves could be converted into a branch as progress continues, thus there would be essentially no upper limit on the value of the account that could be displayed.

Data Display Module

The data display module is configured to present the financial performance on the computing device of the user, thereby providing visual feedback in the form of one or more of digital graphic, graphics, animation, or animations, as will be discussed.

The computing device may contain the necessary software application for the investor feedback system, which inputs the user account information into an algorithm or series of algorithms that may determine a digital graphic, graphics, animation, or animations, to display on the authenticated client device.

The data display module utilizes information from the user goal selection module, the user action module, the data aggregator module, and the graphical conversion module. With such information known, the processor will then cause the display of the appropriate object (as selected in the user action module), and animate or provide a graphic that represents the percentage of progress towards the milestone (using the data from the graphical conversion module). The displayed graphics may include one or more special features that are intended to stimulate investor interest in advancing towards the next milestone, and may include congratulatory or encouraging messaging. The graphic may be accompanied by a sound or audible commentary, such as may be provided by the software electing to play an audio file associated with the graphics displayed. For example, upon achieving milestone or rank, the system may play a celebratory fanfare, fireworks, or crowd applause to provide affirmation for the user's progress toward the milestone.

### EXAMPLE 1

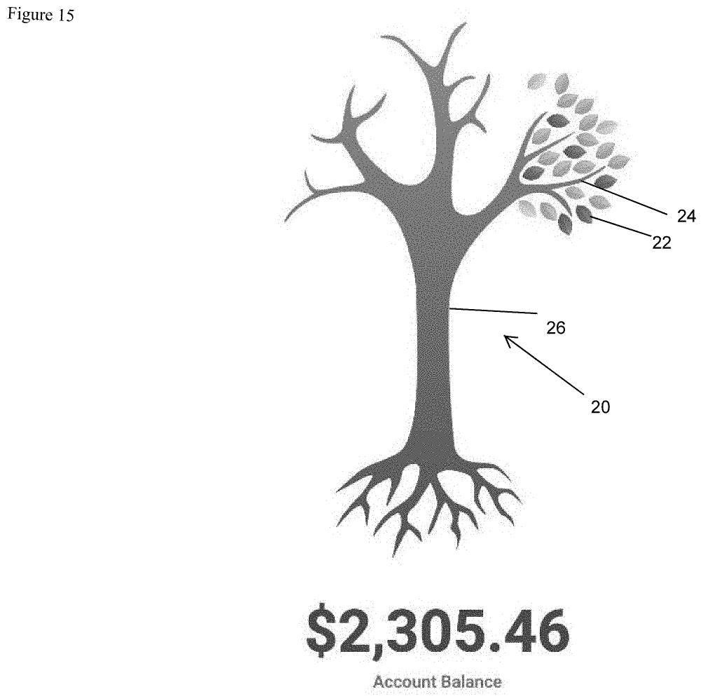

In an exemplary embodiment, such as is depicted in FIG. 15, there is provided an investor feedback system having a graphical conversion module for preparing a graphical representation utilizing a computational procedure for providing feedback to an account owner, by preparing a graphical image, or animation, where the system takes an attribute of the account, such as the currency value of an authenticated user account, and produces a representative graphic that features one or more attributes that vary in proportion with the account attribute, so as to convey information or feedback to the viewer regarding that account attribute. For example, a graphic of a tree 20 may be displayed, depicting a variable number of digital leaves 22 that may be provided on a digital representation of branches 24 on a stem or trunk 26, where the leaves and other aspects of the image collectively may be varied in proportion to the determined account value, which may optionally be depicted below the representative graphic image. An exemplary embodiment is depicted in FIG. 15 and an example of the progression of the exemplary embodiment may be seen with reference to FIGS. 8-15. In this exemplary embodiment, it is contemplated that the number of depicted leaves 22, and or branches 24, if any, would proportionally vary relative to the value of the account monitored, where greater account value is reflected by an increasing number of leaves 22 and/or branches 24 on the tree 20. Additionally, it is contemplated that the condition of the leaves 22 may vary, based on historical aspect of the account, such as the user's contribution history to the account. For this example, where the account holder is making regular or recent contributions into the account, the leaves 22 depicted may be in varying shades of green, with lighter green being reminiscent of new growth, and indicative of recent contributions of funds into the account; and a darker green reminiscent of established growth, indicative of more distant contributions of funds to the account. It is also contemplated that negative feedback may be provided, for example, a portion of the leaves or a portion of one or more leaves may be depicted having shades of yellow, for example, where there have been no recent contributions to an account. Furthermore, where there has been a reduction in value of the account (e.g., through withdrawal or reduction in the investment vehicle share price), it is contemplated that the leaves 22 may turn a shade other than green, for example yellow, orange, red, brown, or may be removed from the tree 20, and depicted scattered on the ground. Alternatively, the displayed object may be altered in some fashion to indicate distress to the tree. Such negative feedback may be reversed, for example, through an increase in contributions to, or an increase in value of the account, thereby causing the leaves to revert to a green color.

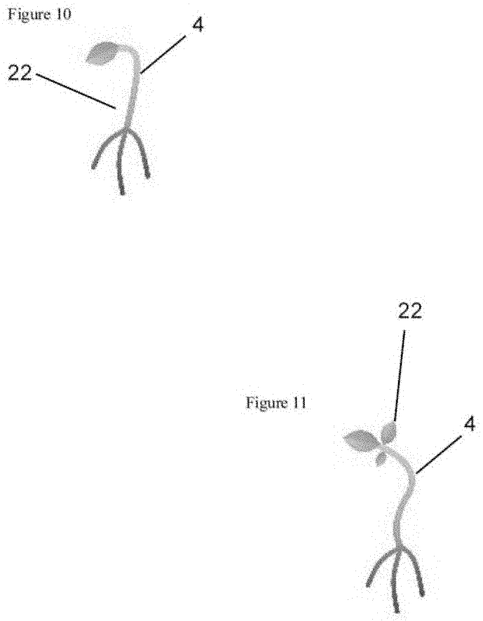

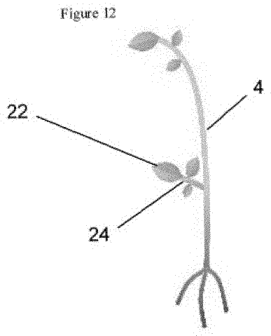

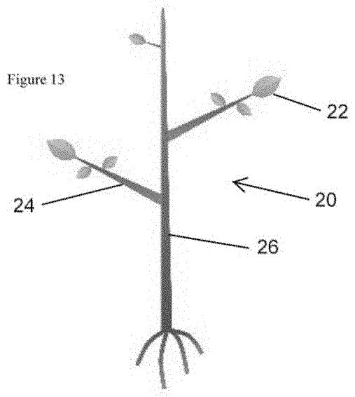

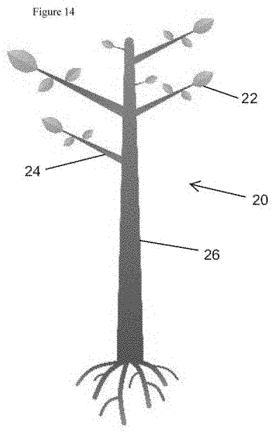

In an exemplary embodiment, there may be depicted a progression of a small seed or sapling, where positive feedback regarding the account is provided by depicting the growth into a larger tree. Such progression can be seen with reference to representative progression stages depicted in FIGS. 8-15, where FIG. 15 is the most advanced represented progression of the mature tree, though the image of FIG. 15 may still be varied to show progression or regression, in that the number of leaves 22 and/or branches 24, at least one of number, placement, and/or color may be adjusted as the account value varies. FIG. 8 is the least advanced progression, represented by a seed 2, and would be representing an initial starting point for the object progression. FIGS. 9-15 are demonstrating increasing levels of progression, with the example stages depicting a seedling 4 with a root system (FIG. 9) or shoot, a single leaf seedling 4 (FIG. 10), a multiple-leaf seedling 4 (FIG. 11), a branched seedling 4 (FIG. 12) with multiple leaves on one or more branches, a branched sapling or small tree 20 (FIG. 13) depicting woody growth to the stem and branches, with multiple leaves on one or more branches, and an immature tree (FIG. 14) with more woody growth.

It is contemplated that, similar to the concept of “levelling up” in many videogames, indicating an increase in rank, the represented element may go through a progression, such as the embodiment depicted of a seed changing to a sapling and then a tree, where progress is depicted in the form of growth, and upon hitting a ranking milestone, for example, a defined account value, the imaged element may transform as the value of the account increases to different quantitative thresholds. Such a transformation would occur when the user is logged onto the software and viewing the image, after the account has achieved the milestone. In this manner, the user would be provided the positive feedback of seeing the transformation on a display when actively viewing the display, rather than the transformation happening solely based upon the milestone being achieved. In an embodiment, the transformation sequence may cause the represented image to transform into a different type of tree. Similarly, the account may lose value, which may trigger the transformation in reverse. The image or animation, in such an instance, may provide encouraging feedback to the user, in the form of a text or audio message, despite a reduction in value of the account. An example of the form of the progression and milestones can be seen with reference to the table depicted in FIG. 16.

Though the example provided has been with reference to an embodiment where progression is depicted in representations various growth stages of a tree, it is contemplated that alternative depictions are possible, and limited only by the imagination of the user, but relying on the teachings herein, any suitable object, character could be adapted to display growth or progression by stages that can be adapted for use herein.

Alternative depiction choices can be seen with reference to FIG. 3 “Examples of Non-Monetary Objects Used to Represent Monetary Goals”, where available options include progression through varied tree or plant forms (where depicted species are replaced with different species as milestones are achieved), or progression of a single tree form (corresponding to example of FIGS. 9-15); or alternative representations such as a dream house, or castle. It is envisioned that alternatives may be substituted, so long as there can be depicted a progression series from an initial starting depiction to a final end point for the object of the progression series depicted.

It is intended that all such additional systems, methods, features and advantages be included within this description, be within the scope of this invention, and be protected by the accompanying claims.

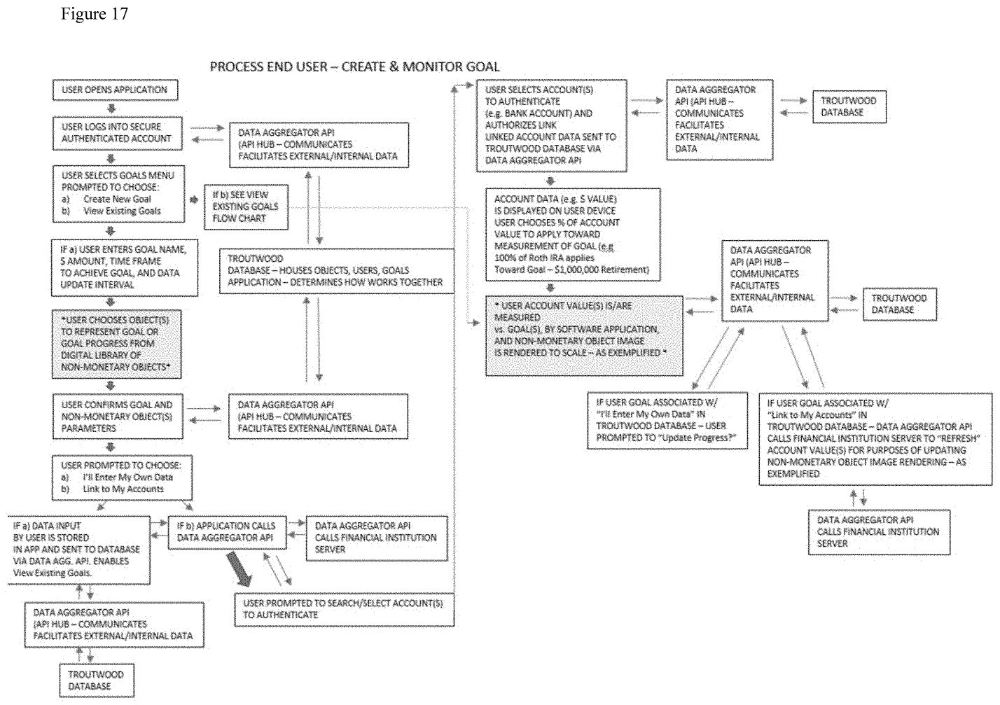

An exemplary process flow for the method of practicing the teachings herein is depicted with reference to FIG. 17. Further details and alternative possibilities to the process flow can be understood with reference to the figure. By way summary of one example process, the user opens the application to begin using the investor feedback system, and account data may optionally be imported from an outside source. The user is then to provide, or has already provided, a goal amount, and optionally a time frame for achieving the goal amount, and also choose an action element from the action element library from which the system will prepare appropriate progression series to be displayed. The user may elect to enter the current account value, or it may be automatically retrieved, whereupon the system may run an algorithm to determine the progress towards the goal, and select the appropriate element to display from the progression series, and cause the element to be displayed on the user's computing device screen.

In the foregoing specification, the invention has been described with reference to specific embodiments thereof. It will be evident, however, that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions, including the ability for the user to personalize. Additionally and obviously, features may be added or subtracted as desired. Accordingly, the invention is not to be restricted except in light of the attached claims and their equivalents.

What is claimed is:

1. An investor feedback system, comprising:
a single general user interface; and
a computer connected to the single general user interface and having:
a computer readable storage device having a database module for collecting, storing, and linking data associated with financial performance of a user account;
a central processing unit connected to the single general user interface and the computer readable storage device, and running a plurality of core modules to display a progressive series of images for an action element representing the financial performance of the user monetary account, the plurality of core modules include:
a user goal selection module configured to allow a user to set a financial goal for the monetary account in numerical value; and
a data display module configured to present a graphical representation of financial performance of the financial goal in view of current status of the monetary account.

2. The investor feedback system of claim 1, further comprising a user action module configured to customize of the graphical representation by selecting an action element consisting of a progressive series of images related to a single graphical form.

3. The investor feedback system of claim 2, wherein the graphical form is a multicellular organism and the progressive series of images shows growth or decay of the multicellular organism.

4. The investor feedback system of claim 2, wherein the graphical form is a tangle item and the progressive series of images shows addition or destruction of the tangible item.

5. The investor feedback system of claim 2, further comprising a data aggregator module configured to gather a real-time value of a user's financial account information related to performance of the monetary account in view of the financial goal.

6. The investor feedback system of claim 5, wherein the data aggregator module communicates with a third party financial institution to receive the real-time value of the user's financial account information.

7. The investor feedback system of claim 5, wherein the data aggregator module gathers the real-time value of a user's financial account information periodically.

8. The investor feedback system of claim 5, further comprising a graphical conversion module to convert real-time value of the user's financial account information into a selected image of progressive series of images in view progression of the financial goal.

9. The investor feedback system of claim 8, wherein the graphical conversion determines a current percentage of progression of the financial goal.

10. The investor feedback system of claim 9, wherein the graphical conversion determines the current percentage of progression of the financial goal in view of a previous status of progression.

11. The investor feedback system of claim 8, wherein the data display module provides an animation of the progressive series of images up to the current percentage progression of the financial goal in view of a previous status of progression.

12. The investor feedback system of claim 11, wherein the data display module includes congratulatory or encouraging messaging upon display of the graphical representation.

13. The investor feedback system of claim 12, wherein the data display module the graphical representation is accompanied by audible commentary.

14. The investor feedback system of claim 1, wherein the monetary account may be a plurality of financial accounts.
